(19) United States
(12) Patent Application Publication
(10) Pub. No.: US 2014/0331237 A1
(43) Pub. Date: Nov. 6, 2014

(54) PLATFORM INDEPENDENT ISA EMULATOR AS MIDDLEWARE

(71) Applicants: Reji S. Kumar, University Place, WA (US); Sridhar R. Iyengar, Portland, OR (US)

(72) Inventors: Reji S. Kumar, University Place, WA (US); Sridhar R. Iyengar, Portland, OR (US)

(21) Appl. No.: 13/997,951

(22) PCT Filed: Dec. 30, 2011
(86) PCT No.: PCT/US11/68227

§ 371 Date: Jun. 25, 2013

(51) Int. Cl. G06F 9/54

(52) U.S. Cl. CPC G06F 9/54
USPC 719/313

(57) ABSTRACT

A hardware/software architecture cars include a high-level software stack on which a plurality of software applications are executing, an underlying hardware platform having a hardware platform type, and a middleware layer residing between the high-level software stack and the underlying hardware platform and configured to allow two or more of the plurality of software applications to interact with each other independent of the hardware platform type.

### TECHNICAL FIELD The disclosed technology relates generally to hardware/software architectures and, more particularly, to middleware for platform-independent architectures.

### BACKGROUND

Currently, operating system (OS) and software application stacks are integrally tied to the platform architecture on which they execute. Consequently, the corresponding back-end architecture must be developed, based on, and starting with, the application programming interfaces (APIs) and instruction sets specific to the particular platform. Unless the native hardware and instruction set is somehow modified to accommodate the needs of the application/OS stacks, the platform may not be viable.

If a legacy application relies on a legacy instruction set architecture (ISA), the platforms and operating systems of today have no way to support it other than natively, which only increases the demands by both sides, resulting in any of a number of negative consequences such as a decrease in efficiency and an increase in power consumption, for example.

Thus, there remains a need for improved hardware/software architectures, particularly with regard to middleware resident therebetween.

### BRIEF DESCRIPTION OF THE DRAWINGS

Embodiments of the disclosed technology are illustrated by way of example, and not by way of limitation, in the drawings and in which like reference numerals refer to similar elements.

FIG. 1 is a block diagram illustrating an example of a current, platform-dependent hardware/software architecture.

FIG. 2 is a block diagram illustrating an example of a platform-independent hardware/software architecture in accordance with certain embodiments of the disclosed technology.

FIG. 3 illustrates an example of a middleware layer, such as the middleware layer in the platform-independent architecture of FIG. 2, in accordance with certain embodiments of the disclosed technology.

FIG. 4 illustrates an example of a device in which certain aspects of embodiments of the disclosed technology may be implemented.

FIG. 5 is a block diagram illustrating an example of a networked system in accordance with certain embodiments of the disclosed technology.

### DETAILED DESCRIPTION

Certain embodiments of the disclosed technology allow applications developed for specific hardware and/or instruction set architectures (ISAs) to be viable, e.g., supported, independent of the type of hardware platform on which they must execute. Such embodiments may serve to eliminate the hardware design specificity and, in some cases, the corresponding overhead, required to support applications that rely on the corresponding hardware and/or ISAs.

Certain implementations include leveraging a flexible, adaptable, and easily modifiable binary emulator to act as the translator between high level application/OS stacks and the corresponding platform hardware architecture, From the perspective of the applications running on the platform, this middleware layer may abstract out the hardware and provide either a universal, e.g., standardized, interface or a programmable emulator interface with which they may communicate. Such embodiments enable the applications to interact with the native hardware on the platform regardless of whether it is an ARM or IA ISA, for example, or virtually any other type of architecture.

Certain implementations may allow for all corresponding applications to be portable regardless of the underlying platform architecture, e.g., ARM or some other type of architecture. Implementations may allow platform hardware designs to shed legacy support, e.g., implemented in hardware, and be essentially unencumbered as they strive for continuous performance improvements through hardware evolution/redesign.

Application stack developers may rely on interface options provided by a middleware layer in accordance with the disclosed technology to communicate with the back-end hardware. Those interface options may include new universal standard instruction sets or, in the case of current ISAs, improved portability of applications associated therewith.

Certain implementations of the disclosed technology may include emulating certain types of functionality rather than implementing such functionality natively. A processor in such an architecture may have enough processing power, e.g., as measured in terms of central processing unit (CPU) and/or graphics processing unit (GPU) capabilities, to emulate an ARM ISA, for example. In this context, binary emulators may be considered middleware.

In certain embodiments involving smaller cores, e.g., minute architectures, instructions having longer latencies may be offloaded to an emulator in order to facilitate a tradeoff in terms of functionality and/or performance. Such embodiments may include a mechanism for offloading legacy ISAs, e.g., x87 ISAs, foreign ISAs, and/or less frequently executed ISAs while maintaining a compatibility layer within middleware. These implementations my be extended to scenarios including the emulation of RS-232 protocols over a universal serial bus (USB) connection to reduce the number of legacy ports, for example.

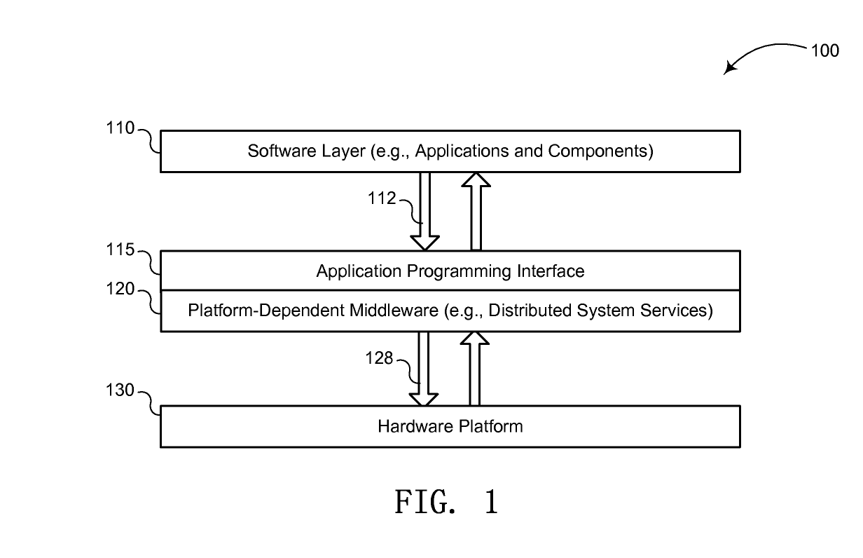

FIG. 1 is a block diagram illustrating an example of a current, platform-dependent hardware/software architecture 100. The architecture 100 includes a software layer 110, e.g., applications and/or software components and a hardware platform 130. A middleware layer 120 interacts with the hardware platform 130, as indicated by bidirectional arrows 112, and also interacts with the software layer 110 by way of an application programming interface layer 115, as indicated by bidirectional arrows 128.

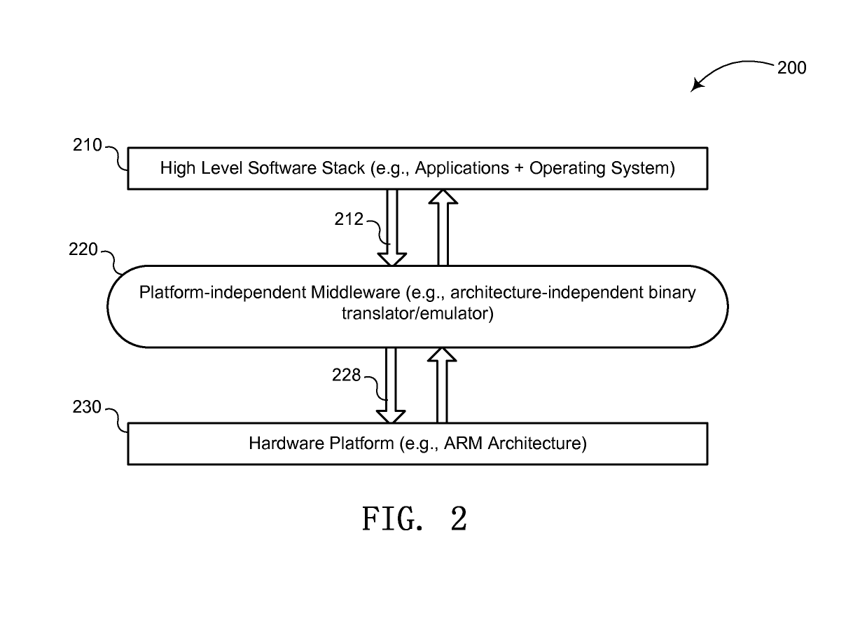

FIG. 2 is a block diagram illustrating an example of a platform-independent hardware/software architecture 200 in accordance with certain embodiments of the disclosed technology. In the example, the architecture 200 includes a high-level software stack 210, e.g., operating system (OS) and software applications, and a hardware platform 230, such as an ARM architecture, for example. The architecture 200 further includes a middleware layer 220 that resides between the high-level software stack 210 and the hardware platform 230. The middleware layer 220 interacts with the software layer 210, as indicated by bidirectional arrows 212, and also interacts with the hardware platform 230, as indicated by bidirectional arrows 228.

In the example, the binary emulator middleware 220 may become a piece of the high-level software stack 210 and thus have any or all of the advantages associated with traditional software, such as flexibility, programmability, and quick turn-around, for example, without the overhead of having to redesign the native hardware platform 230 to support new and/or multiple instruction sets or to improve performance.

In certain embodiments, the middleware layer 220 may enable ARM-based applications to run on other architectures and vice-versa, thus resulting in improved interoperability of both applications and platforms. This may translate to a broadened applicability of platforms, applications, and, ultimately, the number of choices available to the consumer.

In certain implementations, the architecture 200 may allow for offloading the handling of legacy ISAs or low performance ISAs to the middleware 220 in order to free the architecture 200 to target newer performance goals without being encumbered, for example.

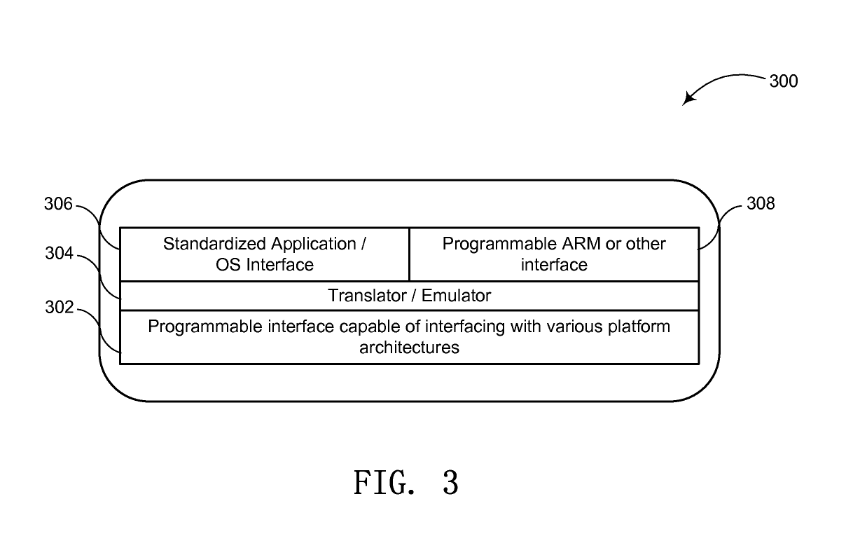

FIG. 3 illustrates an example of a middleware layer 300, such as the middleware layer 220 in the platform-independent architecture 200 of FIG. 2, in accordance with certain embodiments of the disclosed technology. The middleware layer 300 includes a programmable interface 302 that is capable of interfacing with various types of platform architectures. The middleware layer 300 may also include a translator/emulator 304, a standardized application/OS interface 306, a programmable ARM or other interface 308, or any combination thereof.

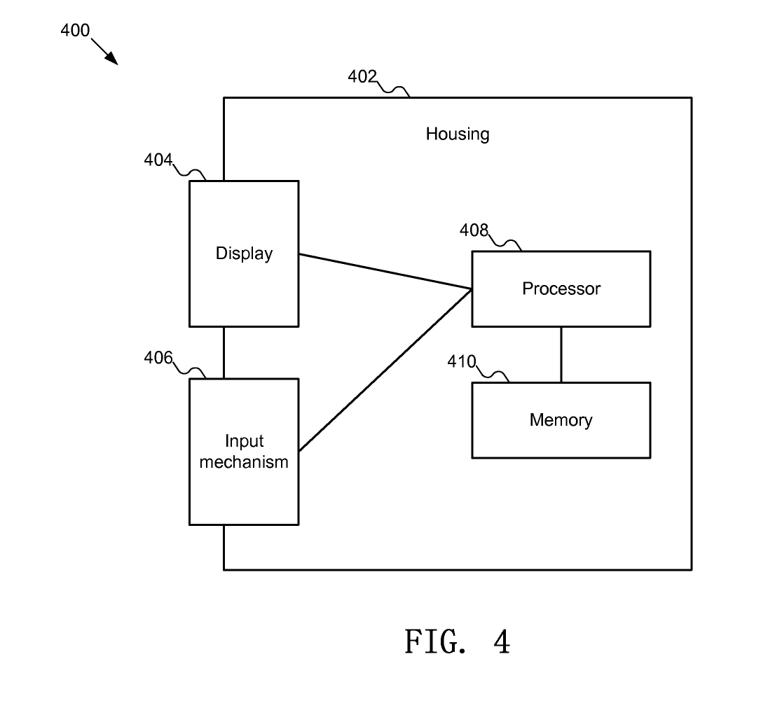

FIG. 4 illustrates an example of a device 400 in which certain aspects of embodiments of the disclosed technology may be implemented. The device 400 may include, but is not limited to, a computing device such as a desktop computer or laptop computer, a mobile device such as a handheld or tablet computer, a communications device such as a smartphone, or an industry-specific machine such as a kiosk or ATM.

The device 400 includes a housing 402, a display 404 in association with the housing 402, an input mechanism 406 in association with the housing 402, a processor 408 within the housing 402, and a memory 410 within the housing 402. The input mechanism 406 may include a physical device, such as a keyboard, or a virtual device, such as a virtual keypad implemented within a touchscreen. The processor 408 may perform virtually any of a number of operations such as those described above. The memory 410 may store information resulting from processing performed by the processor 408.

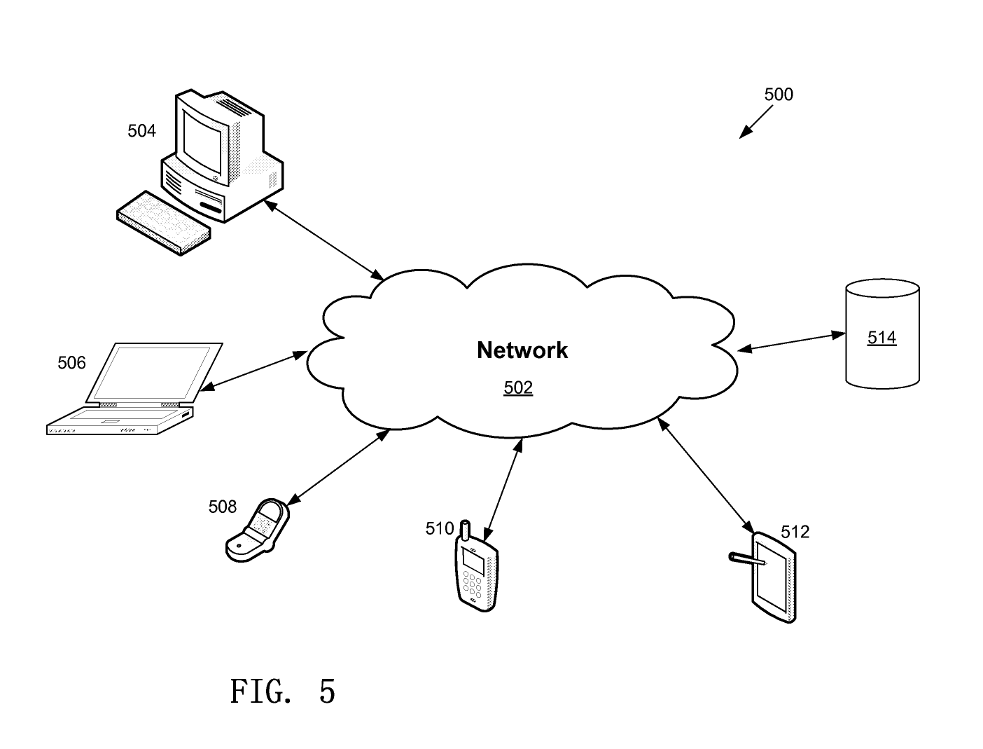

FIG. 5 is a block diagram illustrating an example of a networked system 500 in accordance with certain embodiments of the disclosed technology. In the example, the system 500 includes a network 502 such as the Internet, an intranet, a home network, or any combination thereof Personal computers 504 and 506 may connect to the network 502 to communicate with each other or with other devices connected to the network.

The system 500 also includes three mobile electronic devices 508-512. Two of the mobile electronic devices 508 and 510 are communications devices such as cellular telephones or smartphones. Another of the mobile devices 512 is a handheld computing device such as a personal digital assistant (PDA) or tablet device. A remote storage device 514 may store some of all of the data that is accessed and used by any of the computers 504 and 506 or mobile electronic devices 508-512.

In certain implementations, a platform-independent hardware/software architecture, such as the architecture 200 of FIG. 2, may span any or all of the devices in the illustrated system 500. For example, an application executing on the desktop computer 504 may seek to interact with an application executing on the mobile device 512. The platform-independent architecture may allow and facilitate such communication between the two devices 504 and 512, regardless of the underlying hardware platform.

Embodiments of the disclosed technology may be incorporated in various types of architectures. For example, certain embodiments may be implemented as any of or a combination of the following: one or more microchips or integrated circuits interconnected using a motherboard, a graphics and/or video processor, a multicore processor, hardwired logic, software stored by a memory device and executed by a microprocessor, firmware, an application specific integrated circuit (ASIC), and/or a field programmable gate array (FPGA). The term “logic” as used herein may include, by way of example, software, hardware, or any combination thereof.

Although specific embodiments have been illustrated and described herein, it will be appreciated by those of ordinary skill in the art that a wide variety of alternate and/or equivalent implementations may be substituted for the specific embodiments shown and described without departing from the scope of the embodiments of the disclosed technology. This application is intended to cover any adaptations or variations of the embodiments illustrated and described herein. Therefore, it is manifestly intended that embodiments of the disclosed technology be limited only by the following claims and equivalents thereof.

What is claimed is:

1. A hardware/software architecture, comprising:
a high-level software stack on which a plurality of software applications are executing;
an underlying hardware platform having a hardware platform type; and
a middleware layer residing between the high-level software stack and the underlying hardware platform and configured to allow two or more of the plurality of software applications to interact with each other independent of the hardware platform type.

2. The hardware/software architecture of claim 1, further comprising at least one operating system (OS) in the high-level software stack.

3. The hardware/software architecture of claim 1, wherein the hardware platform type comprises an ARM instruction set architecture (ISA).

4. The hardware/software architecture of claim 1, wherein the middleware layer is further configured to provide interface options comprising new universal standard instruction sets.

5. The hardware/software architecture of claim 1, wherein the plurality of software applications comprises an ARM-based application, and wherein the middleware layer is further configured to enable the ARM-based application to run on a different architecture.

6. The hardware/software architecture of claim 1, wherein the middleware layer is further configured to receive offloaded legacy instruction set architectures.

7. The hardware/software architecture of claim 1, wherein the middleware layer is further configured to receive offloaded low-performance instruction set architectures.

8. The hardware/software architecture of claim 1, wherein the middleware layer comprises an instruction set architecture (ISA) emulator,

9. The hardware/software architecture of claim 1, wherein the middleware layer comprises an architecture-independent binary translator/emulator.

10. The hardware/software architecture of claim 9, wherein the binary translator/emulator is configured to be integrated with the high-level software stack.

11. The hardware/software architecture o claim 9, wherein the binary translator/emulator is flexible, adaptable, and easily modifiable.

12. A system, comprising:
a first device running a first software application using a first operating system (OS);
a second device running a second software application using a second OS;
an underlying hardware platform having a hardware platform type; and
a middleware layer resident between each of the first and second OSes and the underlying hardware platform, the middleware layer being configured to facilitate communication between the first and second software applications regardless of the hardware platform type.

13. The system of claim 12, wherein the middleware layer comprises an architecture-independent binary translator/emulator.

14. The system of claim 12, wherein at least one of the first and second devices comprises a mobile electronic device.

15. A machine-controlled method, comprising:
a middleware layer receiving a request from a first software application executing within a first software stack on a first device to communicate with a second software application executing within a second software stack on a second device in an architecture having a hardware platform, the hardware platform having a hardware platform type; and
the middleware layer granting the request independent of the hardware platform type.

16. The machine-controlled method of claim 15, further comprising offloading legacy instruction set architectures, low-performance instruction set architectures, or both to the middleware layer.

17. The machine-controlled method of claim 15, further comprising the middleware layer providing interface options comprising new universal standard instruction sets.

18. A non-transitory machine-readable medium storing instructions that, when executed by a processor, cause the processor to:
receive a request from a first software application executing within a first software stack on a first device to communicate with a second software application executing within a second software stack on a second device in an architecture having a hardware platform, the hardware platform having a hardware platform type; and
grant the request independent of the hardware platform type.

19. The non-transitory machine-readable medium of claim 18, wherein the instructions further cause the processor to cause legacy instruction set architectures, low-performance instruction set architectures, or both to be offloaded to a platform-independent middleware layer.

20. The non-transitory machine-readable medium of claim 18, wherein the instructions further cause the processor to enable an ARM-based application to run on a different architecture.
